(19) United States
(12) Patent Application Publication
(10) Pub. No.: US 2025/0245283 A1
(43) Pub. Date: Jul. 31, 2025

(54) INFORMATION PROCESSING APPARATUS, CONTROL METHOD OF INFORMATION PROCESSING APPARATUS, INFORMATION PROCESSING SERVER, SYSTEM, AND STORAGE MEDIUM

(71) Applicant: CANON KABUSHIKI KAISHA, Tokyo (JP)

(72) Inventor: HIROYUKI UCHIDA, Chiba (JP)

(21) Appl. No.: 19/033,637

(22) Filed: Jan. 22, 2025

(30) Foreign Application Priority Data
Jan. 29, 2024 (JP) 2024-010999

(51) Int. Cl. G06F 16/958; G06F 16/955

(52) U.S. Cl. CPC G06F 16/958; G06F 16/955

(57) ABSTRACT

An information processing apparatus includes: a reception unit configured to receive a first webpage destined for a predetermined area from a server; an obtainment unit configured to obtain information indicating an area from the server by transmitting a request to determine the area to the server based on a description included in the first webpage; and a display control unit configured to perform control not to display the first webpage but to display a second webpage different from the first webpage in a case where the area indicated by the obtained information does not correspond to the predetermined area.

### BACKGROUND OF THE INVENTION

### Field of the Invention

The present disclosure relates to a technique of properly providing contents for a predetermined area

### Description of the Related Art

There has been known a webpage using the Internet and the like. In general, the webpage is a common page in all the areas; however, some webpages have a function of identifying a resident area of a user using a web browser. Specifically, the web browser that executes a program coming with the webpage transmits a request to determine the area to the web server and receives information of the area according to this request from the web server, and thus the resident area of the user is identified. Japanese Patent Laid-Open No. 2022-010261 discloses a technique in which a web browser obtains information of a resident area of a user and displays a button to display another webpage in a case where the obtained area is a predetermined area.

There has been demanded a technique of proper control to provide a webpage including contents for a predetermined area to a user resident in the predetermined area and not to provide to a user not resident in the predetermined area.

### SUMMARY OF THE INVENTION

An information processing apparatus according to an aspect of the present disclosure includes: a reception unit configured to receive a first webpage destined for a predetermined area from a server; an obtainment unit configured to obtain information indicating an area from the server by transmitting a request to determine the area to the server based on a description included in the first webpage; and a display control unit configured to perform control not to display the first webpage but to display a second webpage different from the first webpage in a case where the area indicated by the obtained information does not correspond to the predetermined area.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration;

FIG. 2 is a diagram illustrating an example of a processing sequence;

FIGS. 3A to 3C are diagrams illustrating an example of a webpage displayed on a web browser;

FIG. 4 is a flowchart illustrating details of information display control processing;

FIG. 5 is a diagram illustrating an example of a target area ID list;

FIGS. 6A and 6B are diagrams illustrating an example of a webpage including contents for a predetermined area;

FIG. 7 is a diagram illustrating an example of a processing sequence; and

FIG. 8 is a flowchart illustrating details of resident area determination processing.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same reference numerals are provided to the same constituents.

### First Embodiment

### Overview

An example of control to provide a webpage including contents for a predetermined area to a user resident in a predetermined area and not to provide to a user not resident in the predetermined area is described below. The contents destined for the predetermined area are, for example, contents related to a service that is different depending on the area. As a specific example, the contents destined for the predetermined area are contents related to a maintenance service of an instrument. In advance to descriptions of a specific embodiment, an example in which the contents destined for the predetermined area are provided is described below. As described above, some webpages have a function of identifying a resident area of a user using a web browser. Hereinafter, this function is also referred to as a resident area determination function. In the resident area determination function, the following processing is performed. The web browser that executes a program coming with a webpage transmits a request to determine an area to a web server. Then, the web browser receives information of the area according to the request from the web server, and thus the resident area of the user is identified on the web browser. This request to determine the area is also referred to as an area determination request.

The area determination request is a request to determine a location area of an information processing apparatus (PC and the like) with the web browser and is, for example, an HTTP request using Hypertext Transfer Protocol (HTTP). A header portion of the area determination request transmitted from the information processing apparatus includes an IP address of the information processing apparatus. This IP address in the header portion of the area determination request is replaced with an IP address of a provider connected to the information processing apparatus until the web server receives the area determination request. Additionally, in some cases, an edge server that relays communication is provided between the provider and the web server. In this case, the edge server includes a correspondence table indicating correspondence between the IP address and the area. Then, with reference to the correspondence table, the edge server applies the information of the area corresponding to the IP address included in the header portion of the relayed area determination request to the header portion of the relayed area determination request. In a case where the web server receives the area determination request as described above, the web server transmits the information of the area applied to the header portion of the area determination request to the information processing apparatus (the web browser) as a response for the transmitted area determination request. The web browser that executes the program coming with the webpage can identify the location area of the information processing apparatus (the resident area of the user) with reference to the response from the web server.

Thus, the resident area determination function is implemented on the webpage. Note that, the above-described example is an example, and a mode without relaying the edge server may be applicable. In this case, the web server may include the correspondence table between the IP address and the area, or a mode in which another server includes the correspondence table and the web server refers to the correspondence table included in the other server may be applicable.

With use of the resident area determination function as described above, in a case where the user resident in the predetermined area tries to perform the processing of displaying the specific webpage on the web browser, it is possible to perform control to redirect to the webpage including the contents destined for the predetermined area.

However, there may occur a state in which a user not resident in the area can access the webpage including the contents destined for the predetermined area through an external webpage such as a search engine. That is, there may occur a state in which the web browser directly accesses the webpage including the contents destined for the predetermined area without going through the specific webpage having the resident area determination function. In a case where the user accesses the webpage including the predetermined contents through the external webpage and the like, there may occur a state in which a service provider cannot properly introduce a service that the user can receive in the resident area. As a result, there may occur a problem that the user falsely recognizes that the contents of the webpage are destined for the area of himself or herself. On the other hand, there may also occur a problem that the user falsely recognizes that the contents destined for the area of himself or herself are not available in the area of himself or herself.

In the embodiments described below, processing of determining the resident area of the user is performed in a case where the webpage including the contents destined for the predetermined area is displayed. In addition, an example in which the false recognition by the user is suppressed by displaying a webpage proper for the resident area of the user in a case where the resident area of the user is not a target area of the contents is described.

### System Configuration

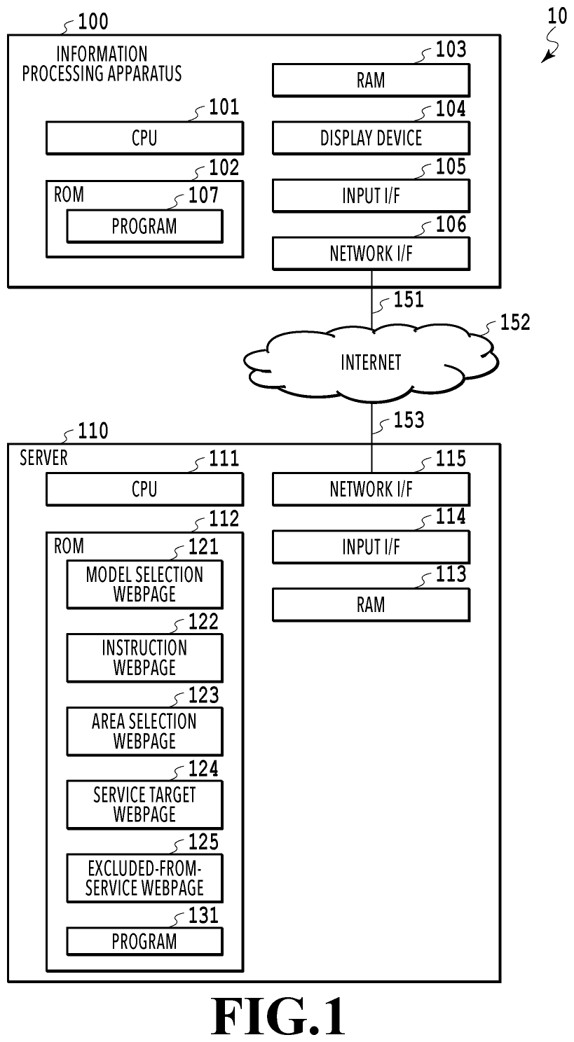

FIG. 1 is a diagram illustrating an example of a system configuration in the present embodiment. An information processing system 10 of the present embodiment includes an information processing apparatus 100, a server 110, and the Internet 152.

The information processing apparatus 100 includes a CPU 101, a ROM 102, a RAM 103, a display device 104, an input interface (hereinafter, referred to as I/F) 105, and a network I/F 106. As the information processing apparatus 100, for example, it is possible to use an arbitrary device such as a personal computer (PC), a smartphone, or a tablet terminal.

The CPU 101 performs various types of control on the information processing apparatus 100. The ROM 102 stores a program 107 such as a web browser. The RAM 103 is used as a temporary storage region and the like. The input I/F 105 receives various inputs from the user. The network I/F 106 is connected with network connection 151. Note that, the web browser is an application program having a function of displaying a webpage by accessing a server on the Internet.

The function of the web browser is implemented with the CPU 101 reading out a program code thereof from the ROM 102 to deploy to the RAM 103. Note that, although an example in which the information processing apparatus 100 includes the display device 104 is illustrated in the example in FIG. 1, a mode in which the information processing apparatus 100 is connected with an external display apparatus by way of an I/F may be applicable. Additionally, the program 107 such as the web browser may also be held in an external storage device.

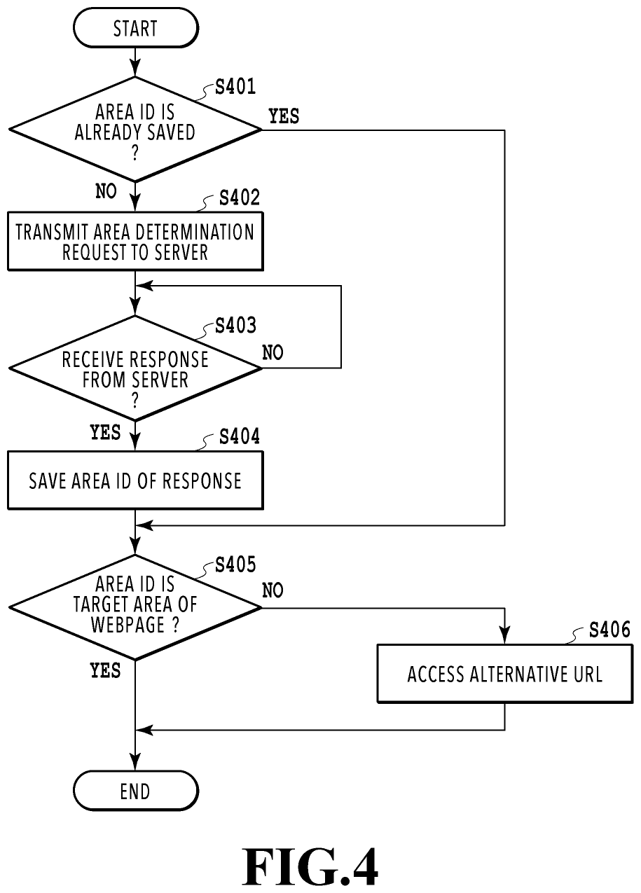

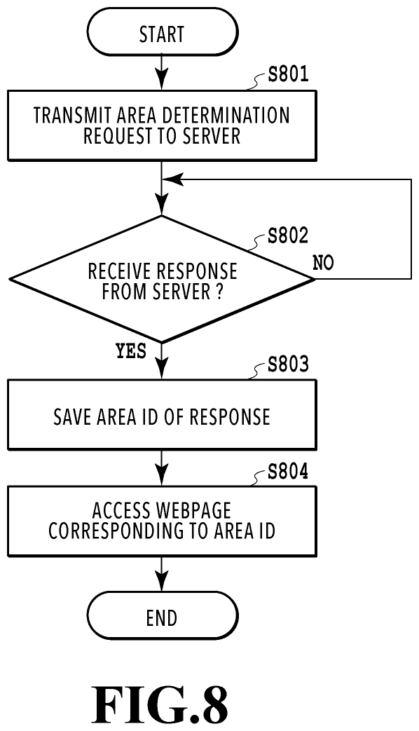

The web browser executed by the CPU 101 secures a storage region to hold an ID corresponding to the resident area of the user in the ROM 102. The user is a user who uses the information processing apparatus 100. The web browser executed by the CPU 101 secures the webpage received from the server 110 and a storage region to hold a program such as JavaScript (registered trademark) and CSS in the RAM 103. The web browser executed by the CPU 101 can execute information display control processing illustrated in FIG. 4 described later and resident area determination processing illustrated in FIG. 8 described later in a second embodiment by using the program held in the RAM 103. The web browser executed by the CPU 101 can receive an operation instruction from the user by way of the input I/F 105.

The information processing apparatus 100 can be connected to the Internet 152 by way of the network connection 151 established by an Ethernet cable or Wi-Fi. The server 110 can be connected to the Internet 152 by way of network connection 153. The information processing apparatus 100 and the server 110 can communicate with each other on the Internet 152.

The server 110 includes a CPU 111, a ROM 112, a RAM 113, an input I/F 114, and a network I/F 115. The CPU 111 performs various types of control on the server 110. The ROM 112 stores various webpages and a program 131 such as JavaScript. The RAM 113 is used as a temporary storage region and the like. The input I/F 114 receives various inputs from the user. The network I/F 115 is connected with the network connection 153.

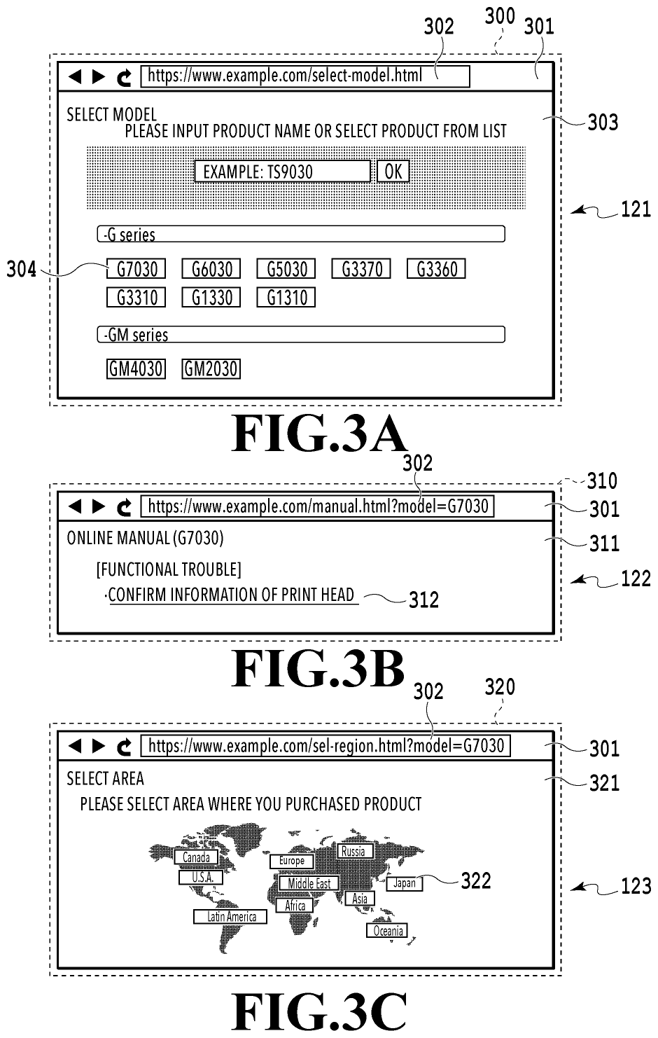

The ROM 112 stores a model selection webpage 121, an instruction webpage 122, an area selection webpage 123, a service target webpage 124, and an excluded-from-service webpage 125. Additionally, the ROM 112 stores the program 131 written in JavaScript, for example. Note that, the program 131 is a program including a description related to an operation of the web browser illustrated in FIGS. 3A to 3C described later.

The service target webpage 124 and the excluded-from-service webpage 125 include a URL (Uniform Resource Locator) corresponding to the program 131. Additionally, the service target webpage 124 and the excluded-from-service webpage 125 include a list of an ID corresponding to a target area of the contents of the corresponding webpages. Note that, the URL or the list included in the webpage is comparable to the URL or the list written in an element forming the webpage (hereinafter, the same applies in the present specification), for example. The list of the ID corresponding to the target area of the contents of the webpage is also referred to as a target area ID list. The target area ID list is included in both the service target webpage 124 and excluded-from-service webpage 125.

The service target webpage 124 includes a URL corresponding to an alternative webpage as an alternative of the service target webpage 124. The URL corresponding to the alternative webpage is also referred to as an alternative URL. The alternative webpage is a webpage displayed instead of the service target webpage 124 in a case where the ID corresponding to the resident area of the user is not included in the target area ID list of the service target webpage 124. It is also possible to say that the alternative webpage is a webpage including the contents proper for the resident area of the user that is displayed in a case where the ID corresponding to the resident area of the user is not included in the target area ID list of the service target webpage 124.

The alternative webpage of the service target webpage 124 is, for example, the excluded-from-service webpage 125; however, another webpage may be applicable. The other webpage is not limited to the webpage held by the server 110 and may be a webpage of another server. The alternative webpage of the excluded-from-service webpage 125 is, for example, the service target webpage 124; however, another webpage may be applicable. The other webpage is not limited to the webpage held by the server 110 and may be a webpage of another server.

The web browser deployed to the RAM 103 of the information processing apparatus 100 functions as an interpreter to execute JavaScript such as the program 131.

### Processing Sequence

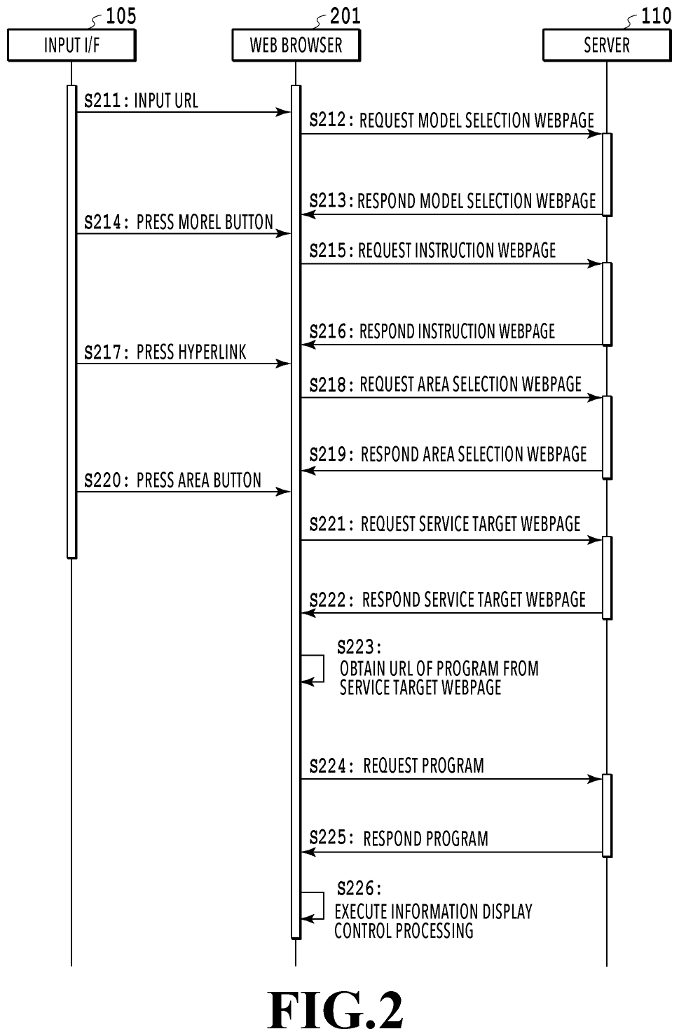

FIG. 2 is a diagram illustrating an example of a processing sequence executed in the information processing system 10 of the present embodiment. FIGS. 3A to 3C are diagrams illustrating an example of the webpage displayed on the web browser.

In FIG. 2, the input I/F 105 of the information processing apparatus 100 receives an operation instruction from the user and transfers the received contents to a web browser 201. That is, the input I/F 105 in FIG. 2 corresponds to a processing operation according to the user instruction. Note that, hereinafter, processing described as the processing executed by the web browser 201 is, to be precise, processing executed with the CPU 101 of the information processing apparatus 100 operating the web browser 201. That is, the processing is implemented by the CPU 101 of the information processing apparatus 100 functioning as the web browser 201 with the CPU 101 reading out the program 107 corresponding to the web browser 201 held in the ROM 102 to the RAM 103 to execute. The processing of the server 110 in FIG. 2 is implemented with the CPU 111 reading out the program (a program different from the program 131 such as JavaScript) stored in the ROM 112 and the like of the server 110 to the RAM 113 to execute. Note that, a part of or all the functions of steps in FIG. 2 may be implemented by hardware such as an ASIC or an electric circuit. A sign “S” in the description of each processing means that it is a step in the sequence diagram (hereinafter, the same applies to the sequence diagram and the flowchart in the present specification). The processing illustrated in FIG. 2 is started after the web browser 201 is activated in the information processing apparatus 100.

In S201, based on the operation instruction from the user, the input I/F 105 of the information processing apparatus 100 inputs a URL corresponding to the model selection webpage 121 of the server 110 into the web browser 201. In S212, in a case where the web browser 201 receives the input of the URL, the web browser 201 requests the server 110 to provide the model selection webpage 121 corresponding to the inputted URL through the network I/F 106.

In S213, in a case where the server 110 receives the request, the server 110 responds the requested model selection webpage 121 to the web browser 201 through the network I/F 115. In a case where the web browser 201 receives the response of the model selection webpage 121, the web browser 201 displays the model selection webpage 121 illustrated in FIG. 3A on the display device 104.

FIG. 3A is a diagram illustrating a screen 300 of the model selection webpage 121 in the present embodiment. The screen 300 of the model selection webpage 121 includes a header display portion 301 and a contents display portion 303. The header display portion 301 includes an address bar 302 to display the URL corresponding to the model selection webpage 121. The contents display portion 303 displays the contents included in the model selection webpage 121. The contents displayed on the contents display portion 303 include multiple model buttons 304. In the present example, a model indicates a model of a printer.

In S214, based on the operation instruction from the user, the input I/F 105 of the information processing apparatus 100 receives pressing of any one of the model buttons 304. Note that, in the present specification, the pressing includes a touch or tap operation on a touch panel display in addition to a click operation by a mouse or a pointing device. The input I/F 105 transfers the pressed model button 304 to the web browser 201.

In S215, the web browser 201 requests the server 110 to provide the instruction webpage 122 of the model corresponding to the pressed model button 304. For example, the instruction webpage 122 is a page including information about how to use or a maintenance method of the printer, and the instruction webpage 122 exists for each model.

In S216, the server 110 responds the instruction webpage 122 corresponding to the model button 304 pressed by the user to the web browser 201 through the network I/F 115. In a case where the web browser 201 receives the response, the web browser 201 displays the instruction webpage 122 illustrated in FIG. 3B on the display device 104.

FIG. 3B is a diagram illustrating a screen 310 of the instruction webpage 122 in the present embodiment. The screen 310 includes the header display portion 301 and a contents display portion 311. The header display portion 301 includes the address bar 302 to display a URL corresponding to the instruction webpage 122. The contents display portion 311 displays the contents included in the instruction webpage 122. The contents displayed on the contents display portion 311 includes a hyperlink 312. The hyperlink 312 is, for example, a hyperlink to introduce information about how to obtain a print head, which is a consumable part of the printer, to the user. Note that, in the present embodiment, the method of obtaining the consumable part described above is different depending on the area.

In S217, the input I/F 105 of the information processing apparatus 100 receives the pressing of the hyperlink 312 in the instruction webpage 122 based on the user operation and transfers the input to the web browser 201.

In S218, in a case where the web browser 201 receives the input of the hyperlink 312, the web browser 201 requests the server 110 to provide the area selection webpage 123 through the network I/F 106.

In S219, the server 110 responds the area selection webpage 123 that is received as the request to the web browser 201 through the network I/F 115. In a case where the web browser 201 receives the response of the area selection webpage 123, the web browser 201 displays the area selection webpage 123 illustrated in FIG. 3C on the display device 104.

FIG. 3C is a diagram illustrating a screen 320 of the area selection webpage 123 in the present embodiment. The screen 320 includes the header display portion 301 and a contents display portion 321. The header display portion 301 includes the address bar 302 to display a URL corresponding to the area selection webpage 123. The contents display portion 321 displays the contents included in the area selection webpage 123. The contents displayed on the contents display portion 321 include multiple area buttons 322.

In a case where the input I/F 105 receives pressing of any one of the area buttons 322 based on the operation instruction by the user, the web browser 201 saves an ID of an area corresponding to the pressed area button 322 in the storage region of the ROM 102. For example, in a case where the pressed area button 322 is “JAPAN”, the ID of the area corresponding to JAPAN is saves in the storage region of the ROM 102. Additionally, based on the reception of the pressing of the area button 322, the web browser 201 requests the server 110 to provide the service target webpage 124 or the excluded-from-service webpage 125.

For example, in a case where the area corresponding to the area button 322 pressed by the user is an area in which the print head is on sale (hereinafter, referred to as a service target area), the web browser 201 requests the server 110 to provide the service target webpage 124. On the other hand, in a case where the area corresponding to the area button 322 pressed by the user is an area in which the print head is not on sale (hereinafter, referred to as an excluded-from-service area), the web browser 201 requests the server 110 to provide the excluded-from-service webpage 125.

Note that, a sales area of the print head is different depending on the model. Therefore, the association between the area button 322 and the webpage requested by the web browser 201 in a case where the area button 322 is pressed is different depending on the model. However, the displayed contents are not varied depending on the model on the contents display portion 321 in FIG. 3C.

In S220, based on the user operation, the input I/F 105 of the information processing apparatus 100 receives the pressing of the area button 322 in the area selection webpage 123 and transfers the pressing to the web browser 201. Note that, it is described herein that the area button 322 that receives the pressing is an area button corresponding to the service target area.

In S221, the web browser 201 requests the server 110 to provide the service target webpage 124 corresponding to the area button 322 pressed by the user through the network I/F 106.

In S222, the server 110 responds the service target webpage 124 that is received as the request to the web browser 201 through the network I/F 115.

In S223, in a case where the web browser 201 receives the response of the service target webpage 124, the web browser 201 obtains the URL holding the program 131 written on the service target webpage 124. In S224, the web browser 201 requests the server 110 to provide the program 131 corresponding to the URL obtained in S223 through the network I/F 106.

In S225, the server 110 responds the program 131 that is received as the request to the web browser 201 through the network I/F 115. In S226, in a case where the web browser 201 receives the response of the program 131, the web browser 201 executes the information display control processing described later based on the program 131.

Note that, the webpage includes a description to refer to the program 131 such as JavaScript. In this case, the web browser 201 is configured to perform processing to obtain the program 131 as a specification of the browser (S224). Additionally, in a case where a command (a script) to execute the program 131 such as JavaScript is written on the webpage, the web browser 201 is configured to execute the script in advance to the displaying of the webpage as the specification of the browser. The web browser 201 is configured to read an HTML file, perform syntax analysis (parsing) in the order of the descriptions, and in a case where there is a script element, synchronously execute a code thereof. That is, the web browser 201 is configured to stop the parsing until the script is executed. In the present embodiment, the web browser 201 is configured to use this property to execute the information display control processing described later in S226 before the web browser 201 displays the contents of the webpage. That is, at the point before S226, it is a state in which the web browser 201 obtains the service target webpage 124 from the server 110 but the contents thereof is not displayed on the display device 104 yet.

Note that, although an example in which the area button 322 pressed in S220 is the area button corresponding to the service target area in the sequence diagram in FIG. 2 is described, it is not limited to this example. The area button 322 pressed in S220 may be an area button corresponding to the excluded-from-service area. In this case, the webpage requested and responded in S221 and S222 is the excluded-from-service webpage. Except this point, the flow of the processing from the request to the server 110 to provide the excluded-from-service webpage 125 by the web browser 201 to the execution of the information display control processing by the web browser 201 is the same as the flow of the processing from S221 to S226.

### Information Display Control Processing

FIG. 4 is a flowchart illustrating details of the information display control processing in S226. The processing of the flowchart illustrated in FIG. 4 is processing executed by the CPU 101 of the information processing apparatus 100 including the web browser 201. That is, the processing is executed by the CPU 101 of the information processing apparatus 100 operating the web browser 201 with the CPU 101 reading out the program 131 received from the server 110 to the RAM 103 to execute. More specifically, the present processing is executed by the web browser 201 with the web browser 201 interpreting the program 131 received from the server 110 by an interpreter in the web browser 201 to execute. That is, it is also possible to say that the present processing is processing executed by the web browser 201 and the information processing apparatus 100, which is caused by the program 131. Additionally, the processing of the flowchart in FIG. 4 is started with the web browser 201 receiving the response of the program 131 from the server 110 (S225) and saving the program 131 in the storage region of the RAM 103.

Note that, in the descriptions of the present embodiment below, it is described assuming that the user presses the area button 322 corresponding to the service target area in S220 in FIG. 2. Additionally, in the descriptions of the present embodiment below, the alternative URL of the service target webpage 124 is assumed to be a URL corresponding to the excluded-from-service webpage 125.

In S401, the web browser 201 executed by the CPU 101 of the information processing apparatus 100 (hereinafter, for the sake of simplification, the subject of the processing is simply described as the web browser) determines whether the ID of the area is saved in the ROM 102. As described in FIG. 2, in the present embodiment, in a case where the pressing of the area button 322 is received on the area selection webpage 123, the web browser 201 performs the processing to save the ID of the area in the ROM 102. This saved ID of the area is saved as Cookie, for example. That is, in S301, the web browser 201 may perform processing to determine whether the ID of the area is saved in Cookie in the ROM 102. Note that, the ID of the area is not limited to be saved in Cookie, and a mode in which the ID is saved in the storage region in the browser or saved as a query parameter may be applicable.

If it is determined that the ID of the area is already saved, the web browser 201 proceeds to S405, and if it is determined that the ID of the area is not saved yet, the web browser 201 proceeds to S402.

In S402, the web browser 201 requests the server 110 to provide the ID corresponding to the resident area of the user through the network I/F 106. That is, since the ID of the area is not saved, the web browser 201 requests the server 110 to respond the area determination request according to the program 131 such as JavaScript. As described above, in a case where the service target webpage 124 is received from the server 110 through the area selection webpage 123, the ID of the area is saved. On the other hand, there may also be a case where the web browser 201 receives the service target webpage 124 from the server 110 without going through the area selection webpage 123. For example, the web browser 201 may directly access the service target webpage 124 through an external search engine and the like. In this case, there is a possibility that an unintended webpage is displayed on the web browser 201 if the resident area of the user does not match the area for the service target webpage 124. Therefore, in S402, the area determination request is performed by the web browser 201 based on the information (including the program 131) included in the service target webpage 124.

The area determination request performed in S402 is the processing described in the beginning of the present embodiment. That is, the area determination request is the HTTP request, for example. Additionally, the header portion of the request to the server 110 stores the IP address of the information processing apparatus 100. The IP address in the header portion of the request to the server 110 is replaced with the IP address of the provider (not illustrated) connected to the information processing apparatus 100 on the Internet 152. In addition, the edge server (not illustrated) on the Internet 152 relaying the communication applies the ID of the area corresponding to the IP address stored in the header portion of the request to the header portion of the area determination request to the server 110. Note that, the edge server includes the correspondence table between the IP address and the area, and processing of converting the IP address into the ID of the area is performed by the edge server. In a case where the server 110 receives the area determination request, the server 110 responds the ID of the area stored in the header portion of the request to the web browser 201 through the network I/F 115.

Note that, the area determination in the present embodiment is performed to determine whether the user is in the service target area. Therefore, for example, instead of the area obtained from language setting of the information processing apparatus 100, setting of the OS, or the like, information of the area obtained by using the above-described system of the area determination request is used.

In S403, the web browser 201 determines whether the response to the transmitted area determination request is received from the server 110. If it is determined that the response is received from the server 110, the web browser 201 proceeds to S404, and if it is determined that the response is not received from the server 110, the web browser 201 proceeds to S403. That is, the web browser 201 repeats the processing in S403 until the response is received from the server 110.

In S404, the web browser 201 saves the ID received as the response from the server 110 in the storage region of the ROM 102.

In S405, the web browser 201 determines whether the saved ID of the area is the target area of the webpage as the processing target. The webpage as the processing target is the webpage received by the web browser 201 from the server 110 in S222. For example, in S405, the web browser 201 determines whether the ID of the area saved in the ROM 102 is included in a target area ID list 500 of the service target webpage 124.

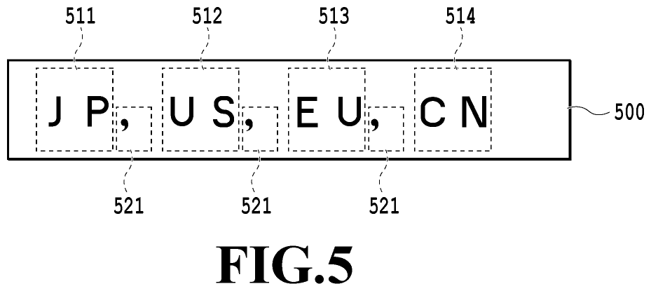

FIG. 5 is a diagram illustrating an example of the target area ID list 500. The target area ID list 500 is, for example, expressed by a character string including the IDs of the multiple areas divided by a comma. The target area ID list 500 illustrated in FIG. 5 includes an ID 511 to an ID 514 corresponding to the areas and a comma 521 to divide the IDs 511 to 514. The ID 511 is a character string that is “JP” indicating Japan. The ID 512 is a character string that is “US” indicating the United States of America. The ID 513 is a character string that is “EU” indicating Europe. The ID 514 is a character string that is “CN” indicating China. The comma 521 is a character string between the ID 511 and the ID 512, between the ID 512 and the ID 513, and between the ID 513 and the ID 514. That is, the target area ID list 500 in FIG. 5 indicates that the webpage as the processing target is the contents for JP, US, EU, and CN.

For example, this target area ID list 500 may be written as an element of HTML such as a meta tag in the webpage or may be written as a JavaScript array. The webpage as the processing target is transmitted from the server 110, and additionally, the program 131 as a source of the processing in FIG. 4 is transmitted from the server 110. That is, the part of the webpage where the target area ID list 500 is located is already known by the server 110 side providing the program 131. Therefore, the program 131 is configured to cause the web browser 201 to refer to the location where the target area ID list 500 is written in S405.

Note that, although the ID included in the target area ID list 500 and the ID saved according to the pressing of the area button in S220 or the ID saved in S404 are in the same format (the same character string) in the present embodiment, it is not limited to this example. As long as the IDs are formed to allow for the comparison of the areas in the processing on the program 131 side, the formats (character strings) are not necessarily the same. Additionally, as for a framework of the area, the ID included in the target area ID list 500 does not necessarily match the ID saved according to the pressing of the area button in S220 or the ID saved in S404. For example, a relationship in which the one contains the other may be applicable. Specifically, a relationship in which the area indicated by the one ID is Japan while the area indicated by the other ID is East Asia may be applicable. In this case, it is also possible to properly perform the determination in S405.

If the web browser 201 determines that the saved ID of the area is the target area of the webpage as the processing target, the web browser 201 ends the processing of the flowchart illustrated in FIG. 4. If it is determined that the saved ID of the area is not the target area of the webpage as the processing target, the web browser 201 proceeds to S406.

In S406, the web browser 201 accesses the alternative URL. That is, the web browser 201 requests the server 110 to provide the webpage (the excluded-from-service webpage 125) corresponding to the alternative URL of the webpage as the processing target (in the present example, the service target webpage 124). As described above, the service target webpage 124 includes the alternative URL corresponding to the alternative webpage. The web browser 201 requests the server 110 to provide the alternative webpage (the excluded-from-service webpage 125) corresponding to this alternative URL. Note that, the flow of the processing from the request to the server 110 to provide the excluded-from-service webpage 125 by the web browser 201 to the reception of the excluded-from-service webpage 125 by the web browser 201 is the same as the flow of the processing from S221 to S222 in FIG. 2. In a case where the web browser 201 executes S406, the web browser 201 ends the processing of the flowchart illustrated in FIG. 4.

Note that, the alternative webpage (the excluded-from-service webpage 125) obtained in S406 also includes the URL of the program 131. Therefore, subsequent to S222 and S223, the processing from S224 to S226 is performed again. After this S406, the processing in FIG. 4 may be repeated with no change in the processing in S226 (the processing of the flowchart in FIG. 4) that is started again. Alternatively, a processing flag may be set in a timing of the processing in S406, and the program 131 may be configured to skip the processing of the flowchart in FIG. 4 in a case where the processing flag is set.

As described above, the webpage is not displayed in the processing of the flowchart in FIG. 4. In a case where the processing of the flowchart in FIG. 4 ends, the web browser 201 restarts the syntax analysis (parsing) of the received webpage that is stopped by the processing of JavaScript as the specification of the browser and displays the webpage.

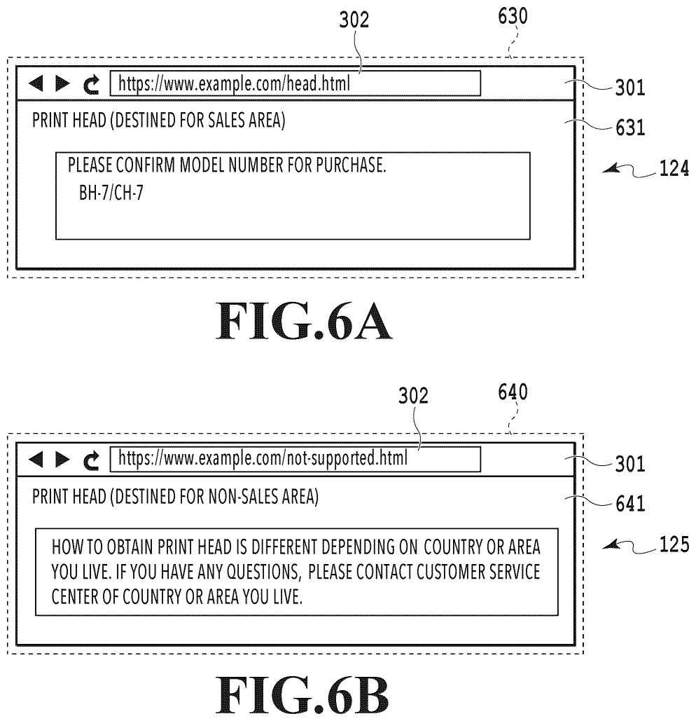

FIGS. 6A and 6B are diagrams illustrating an example of the webpage including the contents destined for the predetermined area. FIG. 6A is a diagram illustrating an example of the service target webpage 124. FIG. 6B is a diagram illustrating an example of the excluded-from-service webpage 125.

After the web browser 201 ends the flowchart illustrated in FIG. 4 without executing S406, the web browser 201 outputs the service target webpage 124 illustrated in FIG. 6A to the display device 104. A screen 630 of the service target webpage 124 includes the header display portion 301 and a contents display portion 631. The header display portion 301 includes the address bar 302 to display a URL corresponding to the service target webpage 124. The contents display portion 631 displays the contents included in the service target webpage 124. The contents displayed in the contents display portion 631 are the contents destined for the area corresponding to the ID included in the target area ID list 500 of the service target webpage 124. In the example in FIG. 6A, a guide destined for the sales area in which the print head is on sale is displayed.

On the other hand, after the web browser 201 executes S406 and then ends the flowchart illustrated in FIG. 4, the web browser 201 outputs the excluded-from-service webpage 125 illustrated in FIG. 6B to the display device 104. A screen 640 of the excluded-from-service webpage 125 includes the header display portion 301 and a contents display portion 641. The header display portion 301 includes the address bar 302 to display the URL corresponding to the excluded-from-service webpage 125. The contents display portion 641 displays the contents included in the excluded-from-service webpage 125. The contents displayed in the contents display portion 641 are the contents destined for the area corresponding to the ID that is not included in the target area ID list 500 of the service target webpage 124. More specifically, the excluded-from-service webpage 125 also includes the target area ID list (a list with different contents from the list in FIG. 5). In addition, the contents displayed in the contents display portion 641 are also the contents destined for the area corresponding to the ID included in the target area ID list of the excluded-from-service webpage 125. In the example in FIG. 6B, a guide destined for the area in which the print head is not on sale is displayed.

As described above, according to the present embodiment, it is possible to properly control to provide the webpage including the contents destined for the predetermined area to the user resident in the predetermined area and not to provide to the user not resident in the predetermined area. For example, in a case where there is no ID corresponding to the resident area of the user in the target area ID list 500 of the service target webpage 124, the web browser 201 can display the webpage proper for the resident area of the user instead. Thus, the contents of the service target webpage 124 are not displayed for the user not resident in the area as the target of the contents of the service target webpage 124. Therefore, it is possible to suppress the false recognition that the contents of the service target webpage 124 are destined for the area of the user himself or herself.

Additionally, in the present embodiment, in a case of going through the area selection webpage 123, the control to skip the area determination request on the service target webpage 124 or the excluded-from-service webpage 125 is performed. Thus, the area determination request is skipped in a case of going through the area selection webpage 123, which is a case of processing of a normal route, and therefore it is possible to expect increase in the processing speed.

Moreover, in the present embodiment, in a case of not going through the area selection webpage 123, and there is a direct access to the service target webpage 124 from the external search engine and the like, it is also possible to provide proper contents according to the resident area of the user. Therefore, for example, it is unnecessary to set an element preventing searching by the search engine to the service target webpage 124 to prevent searching by the user in an area other than the specific area. As a result, an advantageous effect is obtained also in terms of Search Engine Optimization (SEO).

Furthermore, in the present embodiment, the above-described control is implemented on a client side (the web browser 201 side) that receives the program 131. That is, no dynamic processing is performed on the server 110 side. Therefore, a processing system required for the dynamic processing on the server side is unnecessary, and maintenance cost is reduced. Additionally, since no processing is performed on the server side, the risk of vulnerability is reduced. Moreover, it is possible to implement the control on the server that is not compatible with the dynamic processing.

In the above-described embodiment, the service target webpage 124 is used as an example to describe an example of the webpage (also referred to as a first webpage) including the contents destined for the user of the specific resident area. Additionally, the excluded-from-service webpage 125 is used as an example to describe an example of the webpage (also referred to as a second webpage) including the contents destined for the user in an area other than the specific resident area. Both the first webpage and second webpage are the webpage associated with the predetermined area. Specifically, both the first webpage and second webpage are the webpage including the target area ID list. On the other hand, an example of a common webpage not including the target area ID list as described above is described by using the model selection webpage 121, the instruction webpage 122, and the area selection webpage 123 as an example. However, it is not limited to the above-described example. As the common webpage not including the target area ID list described above, a webpage of another type may be used. Additionally, the number of the webpages used as the common webpage is not limited to the above-described example, and any mode may be applicable as long as one or more webpages are used.

### Second Embodiment

In the first embodiment, an example in which the web browser 201 receives the response of the area selection webpage from the server 110 in S219 after the hyperlink is pressed in S217 in FIG. 2 is described. In addition, a mode in which the web browser 201 displays the area selection webpage 123 illustrated in FIG. 3C on the display device 104 based on the response from the server 110 is described. In the present embodiment, a mode in which the area selection webpage 123 is received but the web browser 201 does not display the screen illustrated in FIG. 3C on the display device 104 is described.

A basic configuration of the present embodiment is similar to the example described in the first embodiment; for this reason, the description is omitted, and a different point is mainly described.

Unlike the first embodiment, the area selection webpage 123 in the present embodiment includes a URL corresponding to a program (hereinafter, referred to as a resident area determination program) including a description to execute resident area determination processing illustrated in FIG. 8 described later. Additionally, the resident area determination program is held in the ROM 112 of the server separately from the above-described program 131. The area selection webpage 123 in the present embodiment includes a correspondence table of the ID of the area and the URL of the webpage corresponding to the area (hereinafter, referred to as a URL-by-area table).

### Sequence Diagram

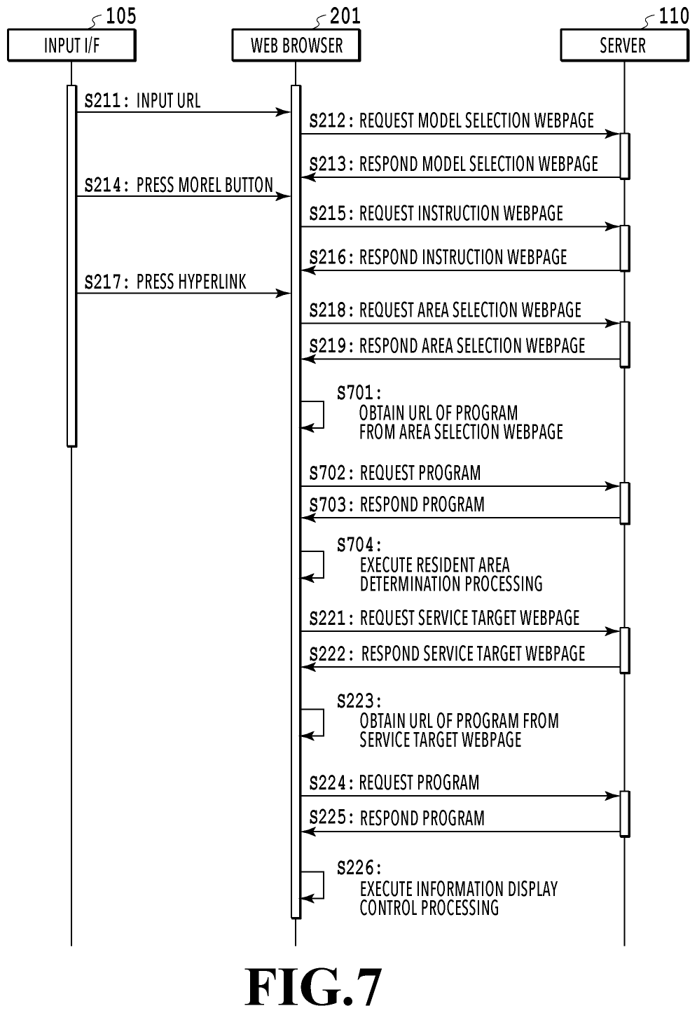

FIG. 7 is a diagram illustrating an example of a processing sequence executed by the information processing system 10 in the present embodiment. In FIG. 7, the same reference numeral as that in FIG. 2 is provided to processing similar to the processing described in FIG. 2. The flow of the processing from S211 to S219 is the same as that in the example described in the first embodiment.

In a case where the web browser 201 receives the response of the area selection webpage 123 in S219, in S701, the web browser 201 obtains the URL corresponding to the resident area determination program from the area selection webpage 123.

In S702, the web browser 201 requests the server 110 to provide the resident area determination program corresponding to the obtained URL through the network I/F 106.

In S703, the server 110 responds the resident area determination program to the web browser 201 through the network I/F 115 based on the received request.

In S704, the web browser 201 executes the resident area determination processing using the resident area determination program based on the received response.

### Resident Area Determination Processing

FIG. 8 is a flowchart illustrating details of the resident area determination processing in S704. The processing of the flowchart illustrated in FIG. 8 is processing executed by the CPU 101 of the information processing apparatus 100 including the web browser 201. That is, the processing is executed by the CPU 101 of the information processing apparatus 100 operating the web browser 201 with the CPU 101 reading out the resident area determination program received from the server 110 to the RAM 103 to execute. The processing of the flowchart in FIG. 8 is started with the web browser 201 receiving the response of the resident area determination program from the server 110 (S703) and saving the resident area determination program in the storage region of the RAM 103.

In S801, the web browser 201 requests the server 110 to provide the ID corresponding to the resident area of the user through the network I/F 106. That is, the web browser 201 transmits the area determination request to the server 110. In S802, the web browser determines whether the response is received from the server 110. If the response from the server is received, the web browser 201 proceeds to S803. In S803, the web browser 201 saves the ID of the area received as the response from the server 110. The processing from S801 to S803 is processing similar to the processing from S402 to S404 in FIG. 4.

In S804, the web browser 201 performs processing to convert the ID of the area in the ROM 102 into the URL by using the URL-by-area table included in the area selection webpage 123 and request the server 110 to provide the webpage corresponding to the URL. Then, the web browser 201 ends the processing illustrated in FIG. 8.

Subsequent to the processing of the processing (S804) in FIG. 8, the processing in S221 in FIG. 7 is performed. That is, the processing in S221 in FIG. 7 is comparable to the processing of requesting the webpage of the URL that is converted from the ID of the area by using the URL-by-area table. Note that, although the converted URL is described as the service target webpage 124 in the example in FIG. 7, the request to the server 110 in S221 may be the provision of the excluded-from-service webpage 125 depending on the resident area of the user. The processing from the request to provide the webpage with the URL converted from the ID of the area by the web browser 201 to the reception of the requested webpage by the web browser 201 is the processing from S221 to S222 in FIG. 7.

Additionally, subsequent to S222, the processing from S223 to S226 is similar to that described in the first embodiment; for this reason, the description herein is omitted.

As described above, according to the present embodiment, the web browser 201 can display the webpage proper for the resident area of the user without the pressing of the area button 322 by the user. Thus, it is possible to suppress the false selection of the area button 322 by the user who is not resident in the area destined for the contents of the service target webpage 124. Therefore, it is possible to suppress the false recognition by the user that the contents of the service target webpage 124 are destined for the area of the user himself or herself. In addition, in the present embodiment, it is also possible to similarly obtain the effect described in the first embodiment.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-010999, filed Jan. 29, 2024, which is hereby incorporated by reference wherein in its entirety.

What is claimed is:

1. An information processing apparatus, comprising:
a reception unit configured to receive a first webpage destined for a predetermined area from a server;
an obtainment unit configured to obtain information indicating an area from the server by transmitting a request to determine the area to the server based on a description included in the first webpage; and
a display control unit configured to perform control not to display the first webpage but to display a second webpage different from the first webpage in a case where the area indicated by the obtained information does not correspond to the predetermined area.

2. The information processing apparatus according to claim 1, further comprising:
a control unit configured to store information indicating a selected area in a predetermined storage region in a case where the area is selected on an area selection webpage to select a resident area.

3. The information processing apparatus according to claim 2, wherein
in a case where the predetermined storage region stores the information indicating the area, the obtainment unit obtains the information indicating the area stored in the predetermined storage region without obtaining the information indicating the area from the server.

4. The information processing apparatus according to claim 2, wherein
in a case where the first webpage is received from the server by way of the area selection webpage, the obtainment unit obtains the information indicating the area stored in the predetermined storage region without obtaining the information indicating the area from the server.

5. The information processing apparatus according to claim 2, wherein
the second webpage is a webpage destined for an area different from the predetermined area.

6. The information processing apparatus according to claim 2, wherein
the second webpage is a common webpage in areas.

7. The information processing apparatus according to claim 2, wherein
the selection of the area on the area selection webpage is performed based on an operation by a user.

8. The information processing apparatus according to claim 2, wherein
the selection of the area on the area selection webpage is performed based on a description included in the area selection webpage.

9. The information processing apparatus according to claim 8, wherein
in a case where the selection of the area on the area selection webpage is performed based on the description included in the area selection webpage, the area selection webpage is not displayed.

10. The information processing apparatus according to claim 8, wherein
the description included in the area selection webpage is a description to execute JavaScript with reference to a URL holding the JavaScript.

11. The information processing apparatus according to claim 1, wherein
the request to determine the area is an HTTP request including an IP address in a header portion.

12. The information processing apparatus according to claim 1, wherein
the display control unit performs control to display the first webpage in a case where the area indicated by the obtained information corresponds to the predetermined area.

13. The information processing apparatus according to claim 1, wherein
the first webpage is formed so as to be searched by an external search engine.

14. The information processing apparatus according to claim 1, wherein
the description included in the first webpage is a description to execute JavaScript with reference to a URL holding the JavaScript.

15. The information processing apparatus according to claim 1, wherein
the first webpage includes a list indicating the predetermined area, and
the display control unit determines whether the area indicated by the obtained information corresponds to the predetermined area by comparing the obtained information with the list.

16. The information processing apparatus according to claim 1, wherein
each unit according to claim 1 is executed by a web browser operating in the information processing apparatus.

17. A server, comprising:
a first transmission unit configured to transmit a first webpage destined for a predetermined area to an information processing apparatus based on a request from a web browser operating in the information processing apparatus;
a second transmission unit configured to transmit information indicating an area to the information processing apparatus based on a request to determine the area that is transmitted from the web browser based on a description included in the first webpage; and
a third transmission unit configured to transmit a second webpage different from the first webpage to the information processing apparatus based on a request from the information processing apparatus in a case where the area indicated by the information transmitted by the second transmission unit does not correspond to the predetermined area.

18. A system, comprising:
an information processing apparatus; and
a server, wherein
the information processing apparatus includes
a reception unit configured to receive a first webpage destined for a predetermined area from a server,
an obtainment unit configured to obtain information indicating an area from the server by transmitting a request to determine the area to the server based on a description included in the first webpage, and
a display control unit configured to perform control not to display the first webpage but to display a second webpage different from the first webpage in a case where the area indicated by the obtained information does not correspond to the predetermined area, and
the server includes
a first transmission unit configured to transmit the first webpage destined for the predetermined area to the information processing apparatus based on the request from a web browser operating in the information processing apparatus;
a second transmission unit configured to transmit the information indicating the area to the information processing apparatus based on the request to determine the area that is transmitted from the web browser based on the description included in the first webpage; and
a third transmission unit configured to transmit a second webpage different from the first webpage to the information processing apparatus based on a request from the information processing apparatus in a case where the area indicated by the information transmitted by the second transmission unit does not correspond to the predetermined area.
